(19) United States
(12) Patent Application Publication
(10) Pub. No.: US 2015/0047518 A1
(43) Pub. Date: Feb. 19, 2015

(54) PRESS ASSEMBLY AND COUPLING MECHANISM FOR SAME

(71) Applicant: ELEMENT SIX LIMITED, SHANNON AIRPORT (IE)

(72) Inventors: Maximilian Voggenreiter, Mainleus (DE); Thomas Heinrich Voggenreiter, Mainleus (DE); Michael Martin Petri, Mainleus (DE)

(21) Appl. No.: 14/384,632

(22) PCT Filed: Mar. 22, 2013
(86) PCT No.: PCT/EP2013/056090

§ 371 Date: Sep. 11, 2014

Related U.S. Application Data
(60) Provisional application No. 61/618,488, filed on Mar. 30, 2012.

(30) Foreign Application Priority Data
Mar. 30, 2012 (GB) 1205731.1

(51) Int. Cl. B30B 12/00

(52) U.S. Cl. CPC B30B 12/00
USPC 100/208

(57) ABSTRACT

A press assembly (100) for pressurising a body, comprising a cartridge (300) for generating a load on the body, a frame (200) comprising a bore for accommodating the cartridge, a chamber for accommodating the body and a fastening mechanism (400) for fastening the cartridge to the frame when the cartridge is inserted into the bore; the bore having an open proximate end into which the cartridge can be inserted and the bore being in communication with the chamber at a distal end. The fastening mechanism is located outside the bore.

This disclosure relates generally to a press assembly, particularly but not exclusively for generating an ultra-high pressure, and a coupling mechanisms for coupling components of same.

U.S. Pat. No. 6,336,802 discloses a unitary press frame and unitary cartridge bodies, the frame comprising intersecting boreholes with means of attachment to the cartridges. Axial threads along the inside diameter wall of boreholes comprise the means of attachment. Other means of attachment may comprise taper, friction, breech and or bolts. A unitary frame is one provided from a single cast or forged component, in contrast with a linked frame, which may comprise six components linked to each other by means of pins, for example.

Viewed from a first aspect there is provided a press assembly for pressurising a body, comprising a cartridge for generating a load on the body, a frame comprising a bore for accommodating the cartridge, a chamber for accommodating the body and a fastening mechanism for fastening the cartridge to the frame when the cartridge is inserted into the bore; the bore having an open proximate end into which the cartridge can be inserted and the bore being in communication with the chamber at a distal end; the fastening mechanism being located outside the bore.

Various combinations and arrangements are envisaged by this disclosure, of which the following are non-limiting, non-exhaustive examples.

In some example arrangements, the press assembly may comprise a number of cartridges and the same number of fastening mechanisms, the frame comprising the same number of bores; each bore being configured for accommodating a respective cartridge and having a respective open proximate end into which the respective cartridge can be inserted; each fastening mechanism being configured for fastening a respective cartridge to the frame when the cartridge is inserted into a respective bore, the fastening mechanism being located outside the bore; the frame being configured such that all bores are in communication with the chamber at respective distal ends of the bores; in which the number is four or six (corresponding to tetragonal and cubic presses, respectively). The frame may have at least the same number of sides, each side provided with a respective bore. The bores are arranged to converge on the chamber. In other words, the bores may be said to converge radially on the chamber (or diverge radially from the chamber) and the chamber may be said to be centrally located with respect to the bores. Each bore may be said to define an axis (a cylindrical axis, passing through both ends of the bore), the axes of all the bores converging substantially to a central point within the chamber. In some other example arrangements, the number may be three or five.

In various example arrangements, the frame may comprise six bores for accommodating six cartridges in each of six sides of the frame; the frame may comprise four bores for accommodating four cartridges in each of four sides of the frame; or the frame may comprise two bores for accommodating two cartridges in each of two opposite sides of the frame.

The fastening mechanism may comprise a support member and a coupler member; the assembly configured so that the cartridge can be retained in the bore by the support member and the support member can be retained by the coupler member, which can be attached to the fixture.

The coupler member may comprise a split ring or clamp. The fixture and the coupler member may each be provided with respective, cooperatively configured inter-engagement structures for inter-locking the coupler member with the fixture. The support body may be an annular structure. The fixture may comprise an annular flange concentric with the bore.

The cartridge may be provided with a shoulder, the cartridge and the fastening mechanism being cooperatively configured so that the fastening mechanism can retain the cartridge in the bore by engaging the shoulder (e.g. abutting the shoulder).

The fixture may comprise a flange projecting from the frame. The flange may project longitudinally from the frame, in relation to the bore (i.e. substantially parallel to the longitudinal axis of the bore.)

The bore may be substantially free of projections for retaining the cartridge axially and or radially within the bore. The cartridge and the bore may be cooperatively configured so that the cartridge can be inserted axially into the bore, without the need for rotation. The bore and or the cartridge may comprise a guide means for guiding the cartridge into the bore.

The press assembly may be suitable for subjecting the body to a pressure of at least about 5 GPa or at least about 7 GPa.

The fastening mechanism may be configured for sustaining a load of at least about 2,000 tons between the cartridge and the frame.

Disclosed example press assemblies have the aspect that high action/reaction forces can be accommodated between the cartridge and the frame. Some examples assemblies have the aspect that the cartridge can be inserted into the bore and coupled to the frame without the need for substantial rotation of the cartridge, which is likely to be particularly advantageous where the cartridge is massive. For example, cartridges for press assemblies for producing diamond products commercially at pressures exceeding about 7 GPa or 8 GPa are likely to weight several tons and it is likely to be preferred that the cartridges can be withdrawn from and inserted into the bores of the frame without substantial rotation or unnecessary handling. This may be particularly so where the press assembly is tetrahedral (i.e. where there are four cartridges arranged in the frame tetrahedrally with respect to each other) or cubic (i.e. where there are six cartridges arranged in a cubic frame), since the cartridges are arranged at various angles with respect to each other and the gravitational force.

Non-limiting example arrangements will be described with reference to the accompanying drawings, of which

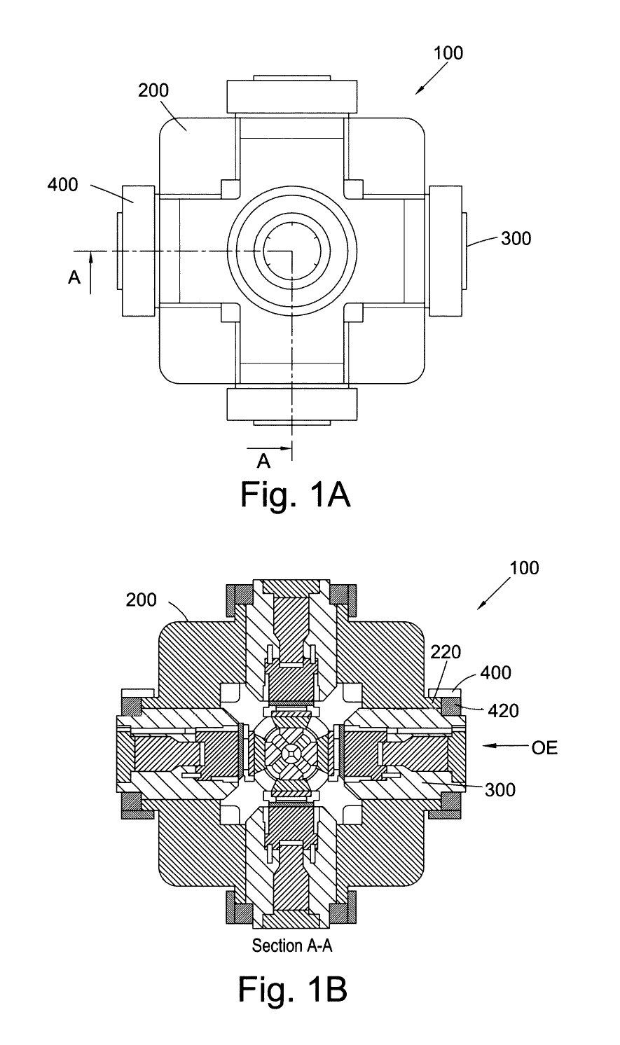

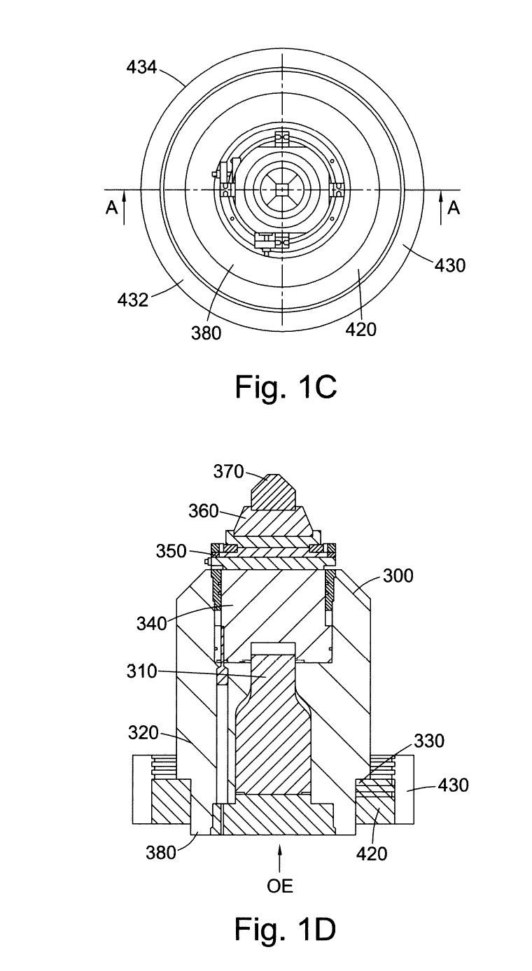

FIG. 1A shows a schematic side view of an example press assembly;

FIG. 1B shows a schematic section view of section A-A of FIG. 1A;

FIG. 1C shows a schematic end view of a load cartridge and example axial fastening mechanism of FIG. 1A;

FIG. 1D shows a schematic longitudinal (axial) cross section through a load cartridge and example axial mechanism of the press assembly shown in FIG. 1A; and

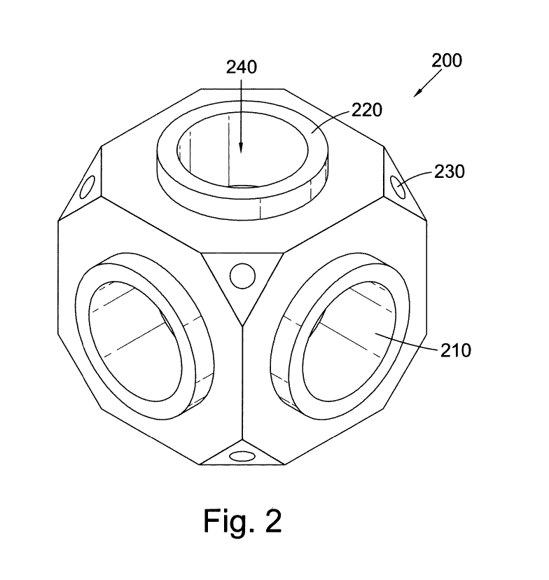

FIG. 2 shows a schematic example of a cubic press frame.

With reference to FIG. 1A to FIG. 1D, an example cubic ultra-high pressure press assembly 100 comprises a unitary steel frame 200 and six hydraulic cartridges 300 fastened to the frame by means of respective fastening mechanisms 400. With reference to FIG. 2, the frame has six major sides, each side provided with a bore hole 210 (also simply referred to as bores) or accommodating a respective cartridge 300. Each cartridge 300 comprises a hydraulically operated piston-cylinder device 310, 320 and an anvil 370 at a distal end thereof for impinging on a capsule (not shown) to be pressurised, which will be housed in a chamber 240 provided in the frame. Each bore hole 210 will communicate with the chamber 240 via an open distal end of the bore hole 210. With reference to FIG. 2, the frame 200 has a central chamber 240 that is substantially spherical (apart from the bore holes 210 that connect the chamber 240 to the outside of the frame 200). In various example arrangements, the central chamber may be substantially cubic, prismatic, a combination of cubic and spherical or a combination of prismatic and spherical. The frame 200 further includes eight ports 230 for accessing the interior of the chamber 240 to insert and extract a capsule (not shown) to be subjected to an ultra-high pressure. The capsule will be substantially cubic or prismatic, having six sides each corresponding to a respective bore hole and cartridge.

The bores 210 and the cartridges 300 are cooperatively configured so that each cartridge 300 can be accommodated within each respective bore 210 to a sufficiently tight tolerance so that the cartridges 300 are not capable of substantial radial displacement within the bore 210. In this particular example arrangement, at least part of the inner volume of the bores 210 are cylindrical and the outer surfaces of the cartridges 300 corresponding to the inner surfaces of the bores 210 are similarly cylindrical. Other arrangements are also envisaged, in which the at least part of the inner surface of the bore and the outer surface of the cartridge may be conical or curved, for example. The inner surface of each bore 210 and the corresponding outer surfaces of each cartridge 300 are substantially smooth and free of projections and the cartridge 300 can freely be displaced axially within the bore 210 when the fastening mechanism is not engaged (e.g. when the cartridge is being inserted or withdrawn). With reference to FIG. 1D, each cartridge 300 comprises a hydraulically operated piston 310 and cylinder 320 mechanism, configured so that the piston 310 can urge forward a ram 340. An X-Y stage 350 is mounted at the front of the ram 340 and an anvil holder 360 is mounted on the X-Y stage and the lateral position of the anvil holder 360 can be adjusted by adjusting the X-Y stage. An anvil 370 for impinging and applying loan onto a capsule in the central chamber of the press frame is mounted on the anvil holder 360.

The cartridge 300 can be fastened to the frame 200 by a mechanism involving clamping a shoulder 330 provided on the load cartridge 300 to a flange 220 provided on the frame 200, by means of a locking ring 420 and a split ring 430. The shoulder 330, locking ring 420, flange 220 and split ring 430 are cooperatively configured so that when the cartridge 300 is fully inserted into the bore 210 the locking ring 420 can be placed against the shoulder 330 and the end surface of the flange 220 and the split ring 430 can secure the locking ring to the flange 220 in a locked condition. When the fastening mechanism is engaged, the split ring 430 secures the locking ring 420 to the flange 220 the locking ring 420 abuts the shoulder 330 on the cartridge 300 and thus secures the cartridge 300 axially to the frame 200. The flange 220 and the split ring 430 are both provided with a plurality of circumferential ribs (and grooves between the ribs), cooperatively arranged so that the respective sets of ribs can interlock (i.e. the ribs of split ring 430 are accommodated in corresponding grooves of the flange 220). A similar interlock arrangement could be provided between the locking ring 420 and the split ring 430.

When the cartridges 300 are in place in each of the six bore holes 210, they may be energised to impinge on the six respective sides of the capsule with sufficient force to generate the ultra-high pressure within the capsule. The bore holes 210 of the frame 200 are substantially smooth and the cartridges 300 are not coupled to the inner surfaces of the bore holes 210 but are substantially free to slide against these surfaces, permitting the cartridges 300 to be inserted into and extracted from the bore holes 210 by a simple axial sliding motion. This will be required for maintenance or repair of a cartridge 300 and for replacing carbide components. The cartridges 300 are coupled to the unitary frame 200 by a clamp mechanism applied at the exterior of the frame and at the back end of the cartridges 300. Thus the back ends of the cartridges 300 are held securely to the unitary frame 200, which has sufficient strength to resist substantially the reaction forces arising when an ultra-high pressure is generated in the capsule by the opposing action of the cartridges 300.

1. A press assembly for pressurising a body, comprising
a number of cartridges for generating a load on the body,
the same number of fastening mechanisms,
a chamber for accommodating the body, and
a frame comprising
the same number of bores configured for accommodating respective cartridges;
each bore having a respective open proximate end into which the respective cartridge can be inserted, and
the frame configured such that all bores are in communication with the chamber at respective distal ends of the bores;
each fastening mechanism being configured for fastening a respective cartridge to the frame when it is inserted into a respective bore;
each bore having an open proximate end into which a respective cartridge can be inserted and
each bore being in communication with the chamber at a distal end; the number of cartridges, fastening mechanisms and bores being four, or six and each fastening mechanism being located outside the respective bore; in which
each fastening mechanism comprises an annular structure and a split ring coupler member or a clamp coupler member;
the assembly configured so that the cartridge can be retained in the bore by the annular structure, and the annular structure can be retained by the coupler member, which can be attached to the frame.

2. (canceled)

3. A press assembly as claimed in claim 1, suitable for subjecting the body to a pressure of at least 5 GPa.

4. (canceled)

5. A press assembly as claimed in claim 1, in which the bore is free of projections for retaining the cartridge.

6. A press assembly as claimed in claim 1, in which the cartridge and the bore are cooperatively configured so that the cartridge can be inserted axially into the bore without the need for rotation.

7. A press assembly as claimed in claim 1, in which the frame comprises six bores for accommodating six cartridges in each of six sides of the frame.

8. A press assembly as claimed in claim 1, in which the frame comprises four bores for accommodating four cartridges in each of four sides of the frame.

9. (canceled)

10. A press assembly as claimed in claim 1, in which the cartridge is provided with a shoulder, the cartridge and the fastening mechanism being cooperatively configured so that the fastening mechanism can retain the cartridge in the bore responsive to the annular structure abutting the shoulder.

11. (canceled)

12. A press assembly as claimed in claim 1, in which the frame comprises a fixture, the fixture and the coupler member being cooperatively configured such that the coupler member can be secured to the fixture.

13. A press assembly as claimed in claim 12, in which the fixture comprises a flange projecting from the frame.

14. A press assembly as claimed in claim 12, in which the fixture comprises an annular flange concentric with the bore.

15. A press assembly as claimed in claim 12, in which the fixture and the coupler member are each provided with respective, cooperatively configured inter-engagement structures for inter-locking the coupler member with the fixture.

16. (canceled)
